(19) United States
(12) Patent Application Publication
(10) Pub. No.: US 2008/0229238 A1
(43) Pub. Date: Sep. 18, 2008

(54) SCALABLE IMAGES USING BITMAPS AND VECTOR IMAGES

(75) Inventor: Kenneth L. Young, Sammamish, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/686,296

(22) Filed: Mar. 14, 2007

(51) Int. Cl. G06F 3/048

(52) U.S. Cl. 715/800

(57) ABSTRACT

An image is rendered on a display to a requested image size using a bitmap of a plurality of bitmaps of the image when the requested image size is less than a bitmap threshold. The image is rendered using vectoring when the requested image size is greater than the bitmap threshold.

### BACKGROUND

An application's User Interface (UI) may include icons. Icons are images displayed in the UI to represent an object that can be manipulated by the user. Icons serve as visual mnemonics and may allow the user to control certain computer actions without having to use keyboard commands. Current methods fail to scale icons adequately at large sizes as well as small sizes.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

Embodiments of the invention provide scaling of images, such as icons, using bitmaps and vector images. An image is rendered using a bitmap or vectoring depending on the requested display size of the image. In one embodiment, an icon may be re-colored to match an application coloring scheme.

Many of the attendant features will be more readily appreciated as the same become better understood by reference to the following detailed description considered in connection with the accompanying drawings.

### BRIEF DESCRIPTION OF THE DRAWINGS

Like reference numerals are used to designate like parts in the accompanying drawings.

FIG. 1 shows icons in accordance with an embodiment of the invention.

FIG. 2 shows a block diagram of rendering an icon in accordance with an embodiment of the invention.

FIG. 3 is a flowchart showing the logic and operations of rendering an icon in accordance with an embodiment of the invention.

FIG. 4 is a block diagram of an icon rendering tool in accordance with an embodiment of the invention.

FIG. 5 is a user interface having icons rendered in accordance with an embodiment of the invention.

FIG. 6 is a user interface having icons rendered in accordance with an embodiment of the invention.

FIG. 7 is a user interface having icons rendered in accordance with an embodiment of the invention.

FIG. 8 is a block diagram of an example computing device for implementing embodiments of the invention.

### DETAILED DESCRIPTION

The detailed description provided below in connection with the appended drawings is intended as a description of the present examples and is not intended to represent the only forms in which the present examples may be constructed or utilized. The description sets forth the functions of the examples and the sequence of steps for constructing and operating the examples. However, the same or equivalent functions and sequences may be accomplished by different examples.

Embodiments of the invention allow images to look equally sharp in small sizes as well as large sizes. Embodiments of the invention are described below in the context of icons displayed in an application User Interface (UI). However, one skilled in the art having the benefit of this description will appreciate that an icon is only one type of image that may be used with embodiments of the invention.

Icons may be rendered using bitmap images or vector images. Bitmap images are made up of pixels in a grid. A computing device may have stored bitmaps in different sizes for a single icon. For example, an icon may have associated bitmaps in sizes (i.e., resolutions) such as 8×8 pixels, 16×16 pixels, 24×24 pixels, 32×32 pixels, etc. When the icon is to be displayed in a UI, the appropriate bitmap for the icon display size is selected and rendered in the UI.

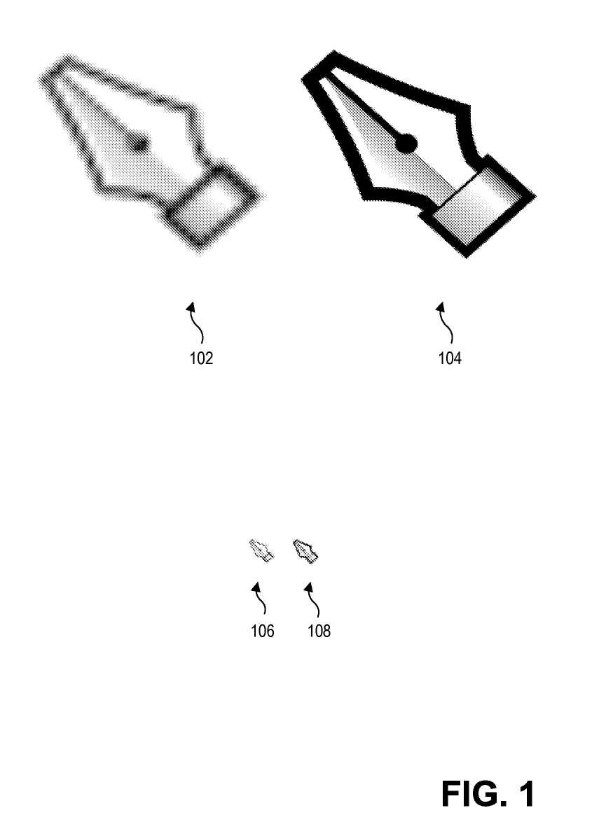

To render an icon at sizes other than the icon bitmap sizes, bitmap scaling may be used. However, bitmap scaling makes icons fuzzy at large sizes. In FIG. 1, at 102, a bitmap of a pen icon has been scaled to a large size. At 104, the same pen icon has been rendered using vectoring. The bitmap image at 102 has jagged edges as the pixels start to appear and is not as smooth as compared to the vector image pen icon at 104.

Vector images include scalable objects defined by mathematical equations. The scalable objects are sized according to parameters placed into the mathematical equations and, thus, are resolution independent (in contrast to bitmaps). Vector imaging may generate a smooth and sharp icon at certain sizes and are much smaller to store than large bitmap images. But at small sizes, vector images may have problems as well; lines may straddle pixels, the image may be poorly aliased and details can resolve on top of each other. Also, at small sizes, vector representations often use more storage than bitmap representations and may take longer to draw. At small sizes, icons produced by vectoring can be cleaned up manually by a human during development of an application. The small size icons can then be saved as bitmaps for use in rendering the icon in the application UI.

In FIG. 1, at 106, the pen icon has been rendered using vector imaging to a small size. The pen icon has aliasing problems along the edge. At 108, the pen icon is displayed with a bitmap. The bitmapped pen icon is sharp and clean.

One solution may be to create a bitmap image specifically for each size including large sizes. However, storing large bitmaps for numerous icons may use a lot of system storage. Also, in 3D graphics, mipmapping is a technique that may be used to scale between several levels of resolution of a texture. Mipmapping may also be used to scale between bitmap resolutions. However, mipmapping is computationally expensive and may be overkill for an icon image. An icon usually has an abstracted appearance; it is desired that the icon is smooth and sharp, but detailed textures are often not needed.

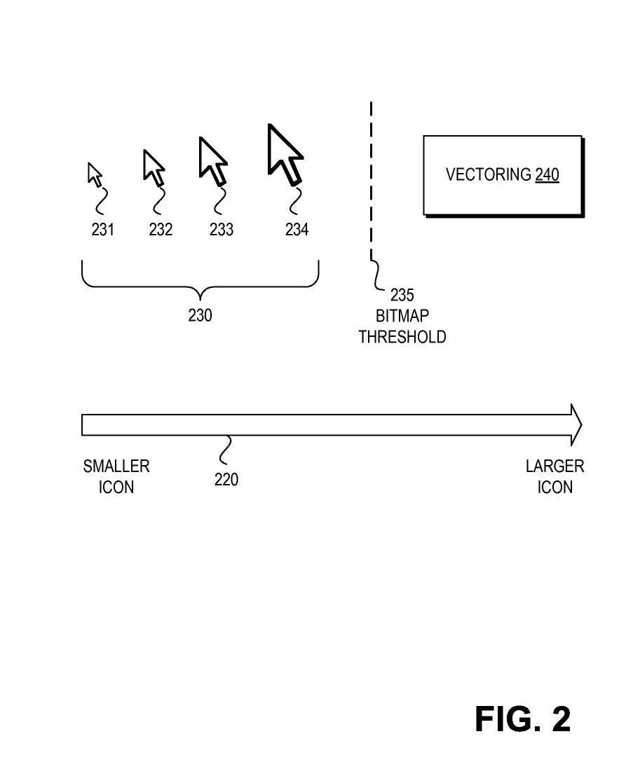

FIG. 2 shows a block diagram of rendering an icon in accordance with an embodiment of the invention. Moving left to right in FIG. 2, arrow 220 shows the rendering of an icon from a small size to a large size. A set of bitmaps for a pointer icon is shown at 230. The set of pointer icons 230 includes four pointer icon bitmaps 231-234. The smallest bitmap is bitmap 231; the bitmaps become progressively larger where bitmap 234 is the largest bitmap. The pointer icon may be rendered by scaling one of the bitmaps from the set of bitmap icons 230. However, when the requested size for the pointer icon is greater than bitmap threshold 235, then the pointer icon is rendered using vectoring 240. Thus, embodiments of the invention combine the advantages of rendering icons with bitmaps at small sizes with the advantages of rendering icons with vector images at large sizes.

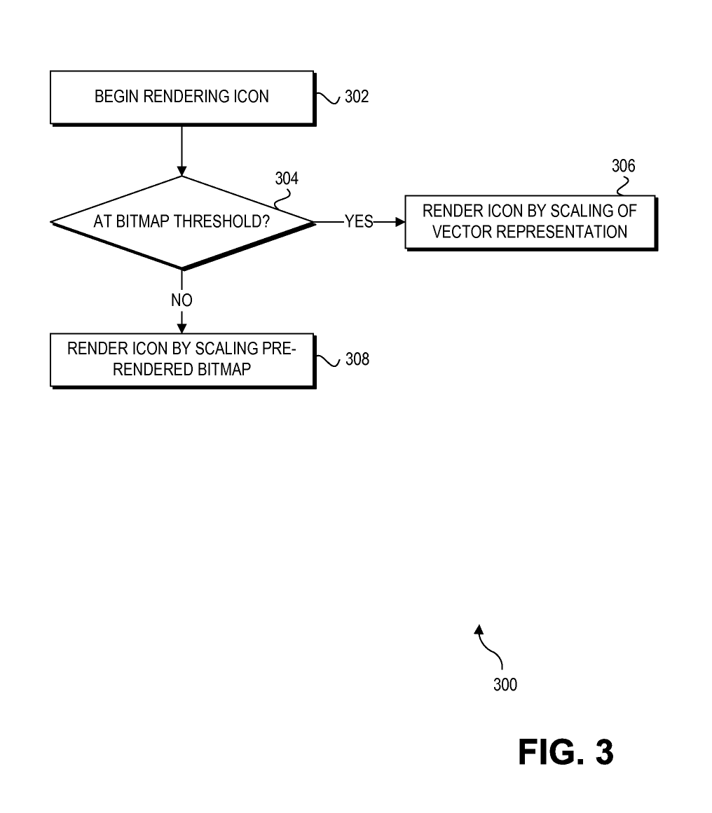

Turning to FIG. 3, a flowchart 300 shows the logic and operations of rendering an icon in accordance with an embodiment of the invention. In one embodiment, at least a portion of flowchart 300 may be implemented using computer readable instructions. Starting in a block 302, the process of rendering an icon is begun. In one embodiment, the icon rendering is started in response to user manipulation of an application UI. For example, the user may be changing the size of the application UI through a workspace zoom function (described further below).

Proceeding to decision block 304, the logic determines if the requested icon size is at a bitmap threshold. In one embodiment, the bitmap threshold is set at the largest icon size that may be displayed with a pre-rendered bitmap. In another embodiment, the bitmap threshold is proportional to the size of the largest bitmap. For example, the bitmap threshold may be set to a size 0-10% larger than the largest bitmap for the icon. In this example, the largest bitmap may be scaled up in size to the bitmap threshold when rendered. The size of the largest bitmap may be measured using pixels per inch (ppi), total number of pixels in the bitmap, bitmap file size, or the like.

If the requested icon size is greater than the bitmap threshold at decision block 304, then the logic proceeds to block 306 to render the icon using scaling of the vector representation of the icon. In one embodiment, the scaling includes arbitrary scaling.

If the answer to decision block 304 is no, then the logic proceeds to block 308 to render the icon by scaling of a pre-defined bitmap. In one embodiment, the logic determines the bitmap that is closest in size to the requested icon size and scales this bitmap accordingly.

In one embodiment, the bitmap threshold in decision block 304 may be modified by a user. In another embodiment, the bitmap threshold may be set based at least on part on the capabilities of the computing device used to render the icon. The logic of flowchart 300 may determine the processor speed, memory size, graphics card capabilities and/or other resource capabilities of the computing device. This capabilities information may be used to set the bitmap threshold for the particular computing device. For example, if the computing device has a low performance graphics card, then the bitmap threshold may be raised to use bitmaps for larger sizes since vector imaging is computationally more expensive than bitmap scaling. Using vectoring to render the application icons may degrade system performance beyond acceptable limits.

In another embodiment of the invention, at least a portion of the icon may be re-colored to match the color scheme of the application UI when the icon is rendered using a bitmap. For example, an application UI may use a blue-green color scheme. When the icon is rendered in the UI, all red colored pixels in the icon are changed to the color of text in the application UI (such as dark green in this example). Thus, a single set of bitmaps for an icon may be stored and then the bitmaps re-colored when rendered to match the UI coloring scheme. Storage space does not have to be wasted storing numerous sets of bitmaps for an icon that have already been colored in various schemes in anticipation of the application's UI color scheme. It will be appreciated that when the icon is rendered using vectoring, the color scheme of the icon is generated to match the application color scheme.

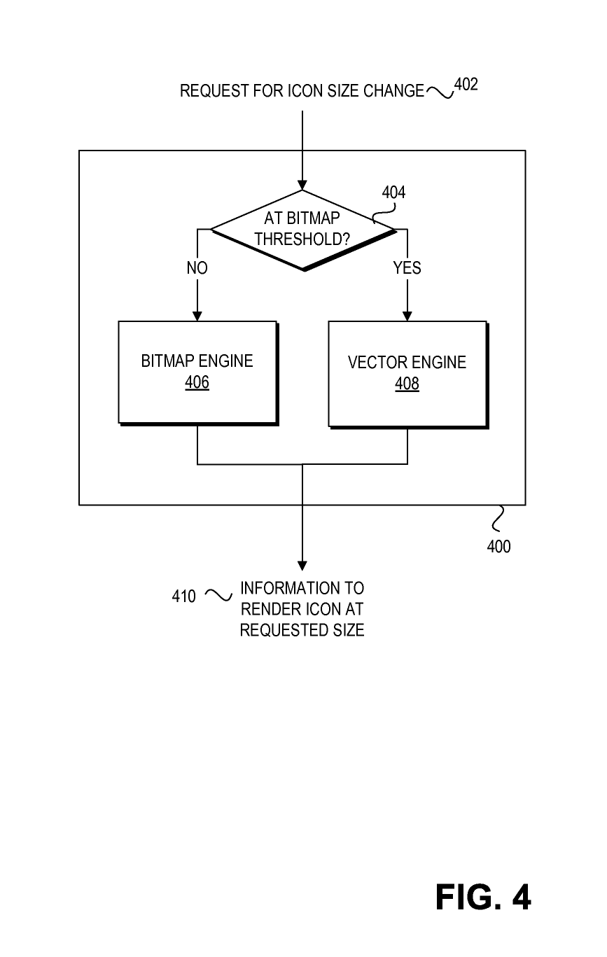

Turning to FIG. 4, an icon rendering tool 400 in accordance with an embodiment of the invention is shown. In one embodiment, at least a portion of tool 400 may be implemented using computer readable instructions. Tool 400 receives a request to change the size of an icon, as shown at 402. In one embodiment, the icon is currently being displayed as part of an application UI. The size change request is made in response to a user zooming in/out of the application UI.

At decision block 404, tool 400 determines if the requested icon size is at the bitmap threshold. If the answer is no, then the tool uses bitmap engine 406 to render the icon image. If the answer to decision block 404 is yes, then tool 400 uses vector engine 408 to render the icon image.

As shown at 410, tool 400 outputs information for rendering the icon at the requested size. This information may then be used to render the icon in an application UI at the requested size.

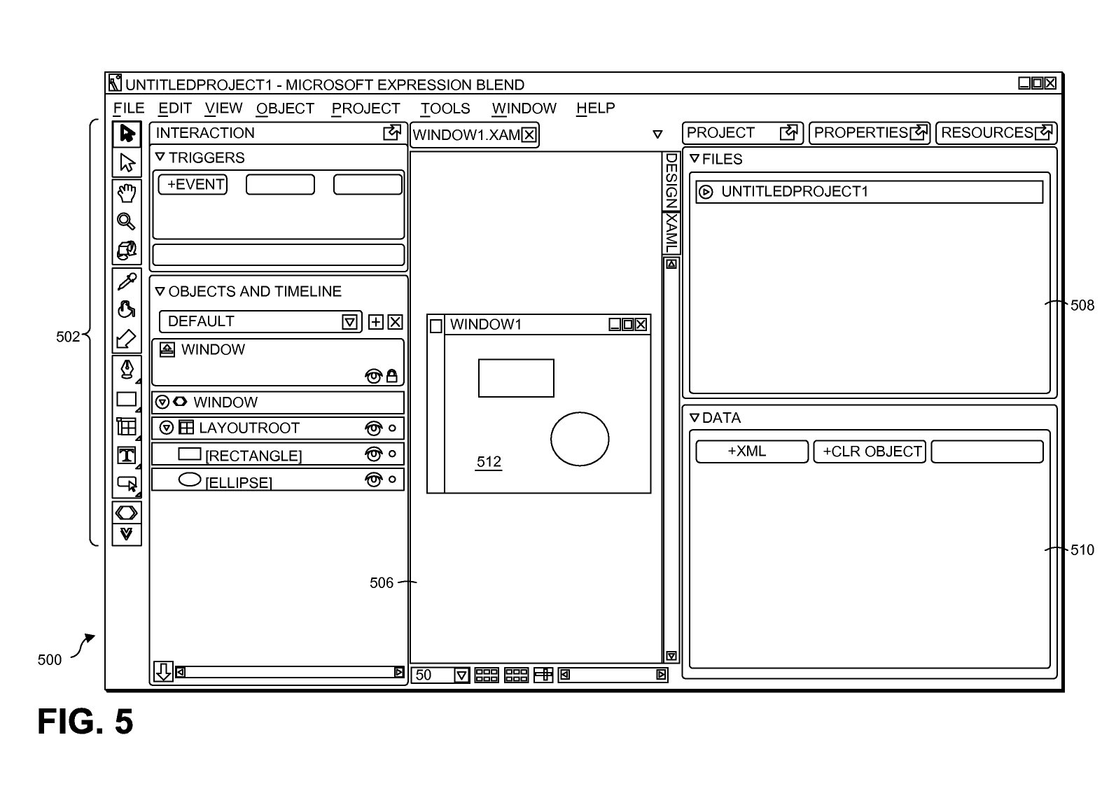

Turning to FIGS. 5-7, screen shots of rendering icons in accordance with embodiments of the invention are shown. FIGS. 5-7 show a UI for Microsoft® Expression Blend™ Beta 2. However, it will be understood that embodiments of the invention are not limited to use with an Expression Blend UI.

FIG. 5 shows an embodiment of a UI 500. UI 500 includes user interface elements, such as artboard 506, panels 508 and 510, toolbox 502, workspace configurations, authoring views, and menus. Artboard 506 holds a project 512 (i.e., application document). Toolbox 502 includes numerous icons, such as a pointer for selecting objects in the UI, a hand for panning in the UI, a magnifying glass for zooming in/out in artboard 506, a pen icon for drawing on artboard 506, a paint bucket for coloring objects, and so on. Embodiments of the invention will be discussed below using the icons in toolbox 502, but it will be understood that embodiments herein may used with any icons or any other images in UI 500.

FIG. 5 shows UI 500 at 100% workspace zoom. Workspace zoom allows the UI to be scaled to a desired size. A user may utilize workspace zoom to zoom out to fit more information on the screen or zoom in for better readability. A slider, menu option, or the like may be used to adjust the workspace zoom. For example, arrow 220 in FIG. 2 may be substituted with a slider to operate workspace zoom in UI 500. Icons in UI 500 would be rendered using bitmaps or vectors in real time as the slider is moved left to right (or right to left) along arrow 220.

It will be appreciated that workspace zoom changes the size of the UI and not an application document (such as project 512) being displayed in the UI. In the embodiment of FIG. 5, icons in toolbox 502 have been rendered using bitmaps.

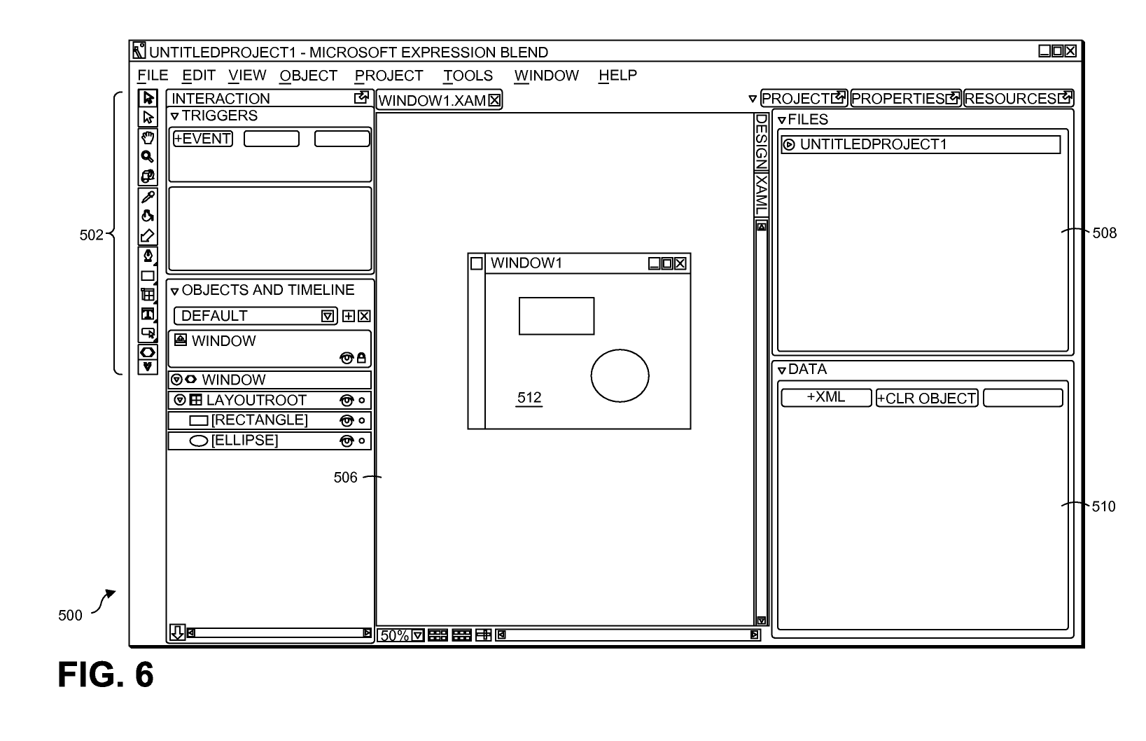

FIG. 6 shows UI 500 at 50% workspace zoom. The icons in toolbox 502 are now resized to a small image size. In FIG. 6, the icons are rendered again using bitmaps. However, different bitmaps than those used in FIG. 5 have been used to show the icons at the smaller size. It will be noted that the size of project 512 has not changed.

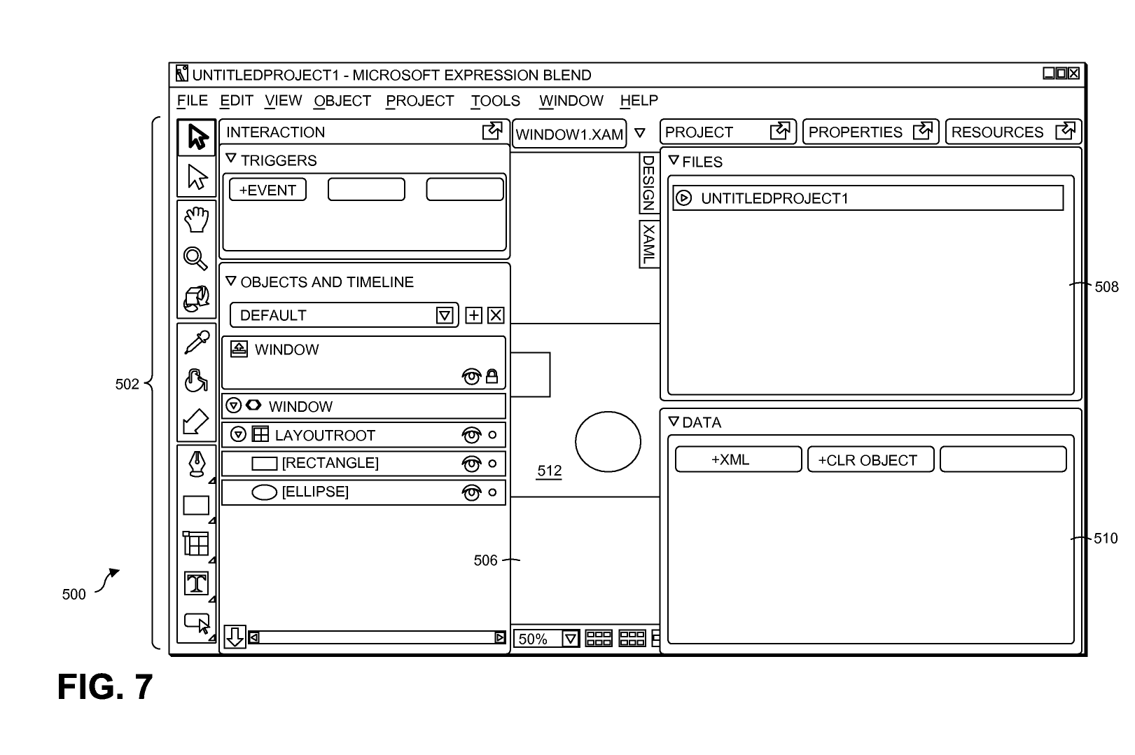

FIG. 7 shows UI 500 at 150% workspace zoom. The icons in toolbox 502 have been rendered using vectoring. The 150% workspace zoom causes the icons to be resized to a size greater than the bitmap threshold. It will be noted that the size of project 512 has not changed in FIG. 7 as compared to FIG. 5 or FIG. 6.

Embodiments of the invention provide scaling of images using bitmaps and vector images. A bitmap is used to render an image at small sizes and a scalable vector version of the image is used for image sizes above the pre-defined bitmaps. Embodiments herein employ the advantages of bitmaps for small size images and the advantages of vectoring for large size images.

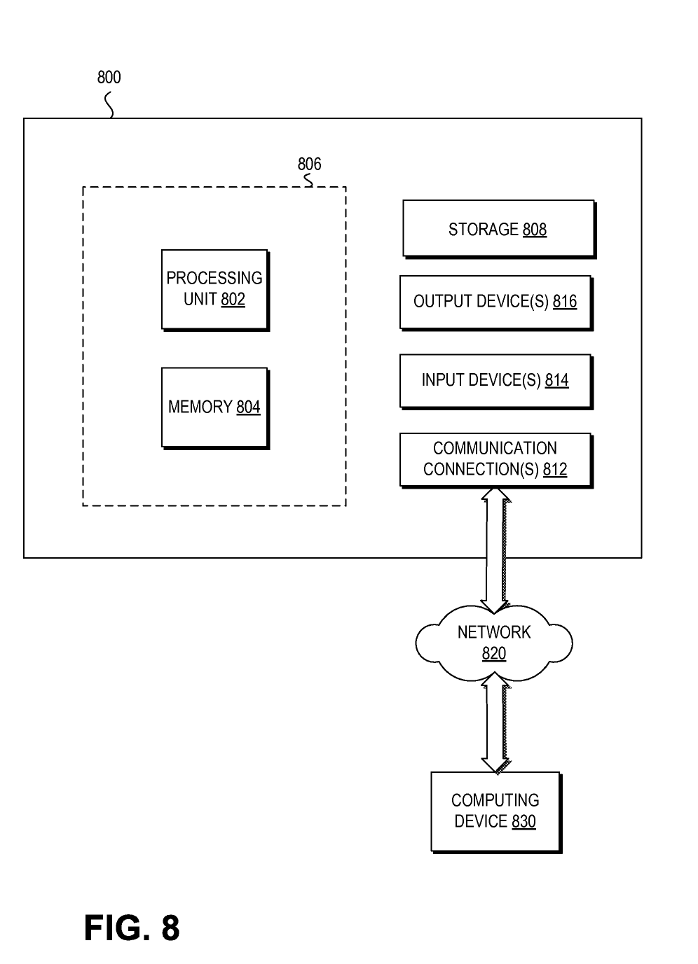

FIG. 8 and the following discussion are intended to provide a brief, general description of a suitable computing environment to implement embodiments of the invention. The operating environment of FIG. 8 is only one example of a suitable operating environment and is not intended to suggest any limitation as to the scope of use or functionality of the operating environment. Other well known computing devices, environments, and/or configurations that may be suitable for use with embodiments described herein include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments of the invention are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 8 shows an example of a computing device 800 for implementing one or more embodiments of the invention. In one configuration, computing device 800 includes at least one processing unit 802 and memory 804. Depending on the exact configuration and type of computing device, memory 804 may be volatile (such as RAM), non-volatile (such as ROM, flash memory, etc.) or some combination of the two. This configuration is illustrated in FIG. 8 by dashed line 806.

In other embodiments, device 800 may include additional features and/or functionality. For example, device 800 may also include additional storage (e.g., removable and/or non-removable) including, but not limited to, magnetic storage, optical storage, and the like. Such additional storage is illustrated in FIG. 8 by storage 808. In one embodiment, computer readable instructions to implement embodiments of the invention may be in storage 808. Storage 808 may also store other computer readable instructions to implement an operating system, an application program, and the like.

The term “computer readable media” as used herein includes computer storage media. Computer storage media includes volatile and nonvolatile, removable and non-removable media implemented in any method or technology for storage of information such as computer readable instructions or other data. Memory 804 and storage 808 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 800. Any such computer storage media may be part of device 800.

Device 800 may also include communication connection(s) 812 that allow device 800 to communicate with other devices. Communication connection(s) 812 may include, but is not limited to, a modem, a Network Interface Card (NIC), an integrated network interface, a radio frequency transmitter/receiver, an infrared port, a USB connection, or other interfaces for connecting computing device 800 to other computing devices. Communication connection(s) 812 may include a wired connection or a wireless connection. Communication connection(s) 812 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared, Near Field Communication (NFC), and other wireless media.

Device 800 may include input device(s) 814 such as keyboard, mouse, pen, voice input device, touch input device, infrared cameras, video input devices, and/or any other input device. Output device(s) 816 such as one or more displays, speakers, printers, and/or any other output device may also be included in device 800. Input device(s) 814 and output device(s) 816 may be connected to device 800 via a wired connection, wireless connection, or any combination thereof. In one embodiment, an input device or an output device from another computing device may be used as input device(s) 814 or output device(s) 816 for computing device 800.

Components of computing device 800 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 800 may be interconnected by a network. For example, memory 804 may be comprised of multiple physical memory units located in different physical locations interconnected by a network.

In the description and claims, the term “coupled” and its derivatives may be used. “Coupled” may mean that two or more elements are in contact (physically, electrically, magnetically, optically, etc.). “Coupled” may also mean two or more elements are not in contact with each other, but still cooperate or interact with each other (for example, communicatively coupled).

Those skilled in the art will realize that storage devices utilized to store computer readable instructions may be distributed across a network. For example, a computing device 830 accessible via network 820 may store computer readable instructions to implement one or more embodiments of the invention. Computing device 800 may access computing device 830 and download a part or all of the computer readable instructions for execution. Alternatively, computing device 800 may download pieces of the computer readable instructions, as needed, or some instructions may be executed at computing device 800 and some at computing device 830. Those skilled in the art will also realize that all or a portion of the computer readable instructions may be carried out by a dedicated circuit, such as a Digital Signal Processor (DSP), programmable logic array, and the like.

Various operations of embodiments of the present invention are described herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment of the invention.

The above description of embodiments of the invention, including what is described in the Abstract, is not intended to be exhaustive or to limit the embodiments to the precise forms disclosed. While specific embodiments and examples of the invention are described herein for illustrative purposes, various equivalent modifications are possible, as those skilled in the relevant art will recognize in light of the above detailed description. The terms used in the following claims should not be construed to limit the invention to the specific embodiments disclosed in the specification. Rather, the following claims are to be construed in accordance with established doctrines of claim interpretation.

What is claimed is:

1. A method, comprising:
rendering an image on a display to a requested image size using a bitmap of a plurality of bitmaps of the image when the requested image size is less than a bitmap threshold; and
rendering the image using vectoring when the requested image size is greater than the bitmap threshold.

2. The method of claim 1 wherein the bitmap threshold is associated with a largest bitmap of the plurality of bitmaps.

3. The method of claim 2 wherein the bitmap threshold is proportional to the largest bitmap.

4. The method of claim 1 wherein the bitmap threshold is based at least in part on capabilities of a computing device to render the image using vectoring.

5. The method of claim 1, further comprising:
receiving a request to render the image at the requested image size on the display, wherein the request is associated with a request to change a size of an application user interface, wherein the image is part of the application user interface.

6. The method of claim 1 wherein rendering the image on the display to the requested image size using the bitmap includes re-coloring at least a portion of the bitmap to match a color scheme of an application associated with the image.

7. The method of claim 1 wherein the image includes an icon of an application user interface.

8. One or more computer readable media including computer readable instructions that when executed perform the method of claim 1.

9. One or more computer readable media including computer readable instructions that when executed by a computing device perform operations comprising:
receiving a request to render an icon at a requested icon size in an application user interface displayed at the computing device;
rendering the icon at the requested icon size using a bitmap of a plurality of bitmaps of the icon when the requested icon size is less than a bitmap threshold; and
rendering the icon at the requested icon size using vectoring when the requested icon size is greater than the bitmap threshold.

10. The one or more computer readable media of claim 9 wherein the bitmap threshold is associated with a largest bitmap of the plurality of bitmaps.

11. The one or more computer readable media of claim 10 wherein the bitmap threshold is proportional to the largest bitmap.

12. The one or more computer readable media of claim 9 wherein the bitmap threshold is based at least in part on capabilities of the computing device to render the icon using vectoring.

13. The one or more computer readable media of claim 9 wherein the request is associated with a user request to change a size of the application user interface, wherein the icon is part of the application user interface.

14. The one or more computer readable media of claim 13 wherein the user request to change the size of the application user interface does not change the size of an application document displayed in the user interface.

15. The one or more computer readable media of claim 9 wherein rendering the icon at the requested icon size using the bitmap includes re-coloring at least a portion of the bitmap to match a color scheme of the application user interface.

16. The one or more computer readable media of claim 15 wherein re-coloring at least a portion of the bitmap includes re-coloring the at least a portion of the bitmap to a color of the application user interface.

17. A system, comprising:
a display;
a processing unit coupled to the display;
one or more computer readable storage media coupled to the processing unit, wherein the one or more computer readable storage media including computer readable instructions that when executed by the processing unit perform operations comprising:
receiving a request to change a size of an application user interface displayed at the display, wherein changing the size of the application user interface includes changing a size of an icon in the application user interface to a new icon size;
rendering the icon at the new icon size using a bitmap of a plurality of bitmaps of the icon when the new icon size is less than a bitmap threshold; and
rendering the icon at the new icon size using vectoring when the requested icon size is greater than the bitmap threshold.

18. The system of claim 17 wherein the bitmap threshold is associated with a largest bitmap of the plurality of bitmaps.

19. The system of claim 17 wherein the bitmap threshold is based at least in part on capabilities of the system to render the icon using vectoring.

20. The system of claim 17 wherein rendering the icon at the new icon size using the bitmap includes re-coloring the bitmap to match a color scheme of the application user interface.
